(19) United States
(12) Patent Application Publication
(10) Pub. No.: US 2008/0031174 A1
(43) Pub. Date: Feb. 7, 2008

(54) Relay

(75) Inventors: Yousuf Saifullah, Richardson, TX (US); Shashikant Maheshwari, Irving, TX (US); Haihong Zheng, Coppell, TX (US)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/819,968

(22) Filed: Jun. 29, 2007

Related U.S. Application Data
(60) Provisional application No. 60/817,400, filed on Jun. 30, 2006.

(51) Int. Cl. G08C 17/00; H04B 7/14

(52) U.S. Cl. 370/311; 455/15

(57) ABSTRACT

A relay for use in a communications network. The relay is configured to receive data from and transmit data to at least one higher level node and receive data from and transmit data to at least one lower level node. The relay includes a processor configured to control the relay so that the relay is configured to enter a power saving mode.

This application claims priority of U.S. Provisional Patent Application Ser. No. 60/817,400 filed on Jun. 30, 2006. The subject matter of this earlier filed application is hereby incorporated by reference.

### FIELD OF THE INVENTION

The present invention relates to a relay, a method of forwarding signals and a communication system. The relay is in particular but not exclusively part of a multilevel relay chain.

### BACKGROUND OF THE INVENTION

Networks using relay units for forwarding of information are well known. In wireless networks such as cellular wireless networks, it is known to provide relay units for signals transmitted from base transceiver stations. In such arrangements the radio signal transmitted by a base transceiver station is received by a relay unit and is retransmitted by the relay unit, typically to a mobile terminal or other user equipment.

Currently, there is a challenge to ensure that there is sufficient coverage in a wireless network in order to provide high data rate services. With the current systems, usually only user equipment close to base stations have a potential for high data rates as the possible bandwidth which is limited by data error rates from the user equipment to the base station is strongly correlated to the inverse of the distance. Therefore in order to achieve high data rate coverage, a greater number of base stations are required. However, increasing the number of base stations is costly.

Relay units, relays or relay stations have been proposed in order to distribute the data more evenly in the cell. However, there are problems associated with integrating relays or relay units into a wireless communication system.

One of the current problems associated with relay stations and particularly when the relay station is mobile and owned by a client is one of relay station energy consumption. Relay stations can be used by the client to provide a mobile access point covering various parts of a client premises. In this role the relay station is used without being attached to a permanent power source and relies on batteries or alternative replaceable power sources. In these cases, the relay station in order to conserve the limited power resources needs to be very power efficient.

Although there are elements within the standards dictating the use of relay stations such as IEEE 802.16 (which is also known as WiMax), enabling power efficiency between the base station and the user equipment so that the user equipment is power efficient and therefore conserves user equipment limited power resources, these energy efficiencies are not passed on to the relay station as the relay station is required to be active at all times.

### SUMMARY OF THE INVENTION

It is an aim of embodiment of the present invention to address or at least mitigate this difficulty.

There is provided according to the invention a relay for use in a communications network, said relay arranged to receive data from and transmit data to at least one higher level node and receive data from and transmit data to at least one lower level node, wherein the relay comprises: a processor arranged to control the relay so that the relay is arranged to enter a power saving mode.

The processor is preferably arranged in the power saving mode to not receive any messages from the at least one higher level node.

The processor is preferably arranged in the power saving mode not to transmit any messages to the at least one higher level node.

The processor is preferably arranged in the power saving mode to receive any messages from the at least one lower level node.

The processor is preferably arranged to detect the at least one lower level node is in a lower level node power saving mode.

The processor is preferably arranged to transmit a message to the at least one higher level node requesting the relay to enter a power saving mode.

The processor is preferably arranged to detect the lower level node power saving mode sleep period and/or receive period.

The processor is preferably arranged to control the relay to enter the power saving mode when the at least one lower level node is not in the receive period.

The processor is preferably arranged to receive a message from the higher level node to enter the power saving mode for a specified period.

The processor is preferably arranged to communicate to at least two lower level nodes, and wherein the processor is arranged to detect that all of the at least two lower level nodes are in a lower level node power saving mode.

The processor is preferably further arranged to detect the lower level node power saving receive periods for all of the lower level nodes.

The processor is preferably further arranged to control the relay to enter the power saving mode when at least one of the at least two lower level nodes is not in the receive period.

The processor is preferably further arranged detect a period between a first lower level node power saving mode receive period and a second lower level node power saving mode receive period.

The processor is preferably arranged to transmit a message to the at least one higher level node requesting a reduction of the period between a first lower level node power saving mode receive period and a second lower level node power saving mode receive period.

The processor is preferably arranged to transmit a message to the at least one higher level node requesting at least one of the first and second lower level node power saving mode receive periods is modified, so that the period between a first lower level node power saving mode receive period and a second lower level node power saving mode receive period is reduced.

The processor is preferably arranged to transmit a message to at least one of the first and second lower level nodes requesting at least one of the respective first and second lower level node power saving mode receive periods is modified, so that the period between a first lower level node power saving mode receive period and a second lower level node power saving mode receive period is reduced.

According to a second aspect of the invention there is provided a base station for use in a communications network, said base station arranged to receive data from and transmit data to at least one relay directly and further arranged to receive data from and transmit data to at least one user equipment via the relay, wherein the base station comprises: a processor arranged to transmit a message to the relay requesting the relay to enter a power saving mode.

The relay is preferably arranged in the power saving mode to not receive any messages from the base station.

The relay is preferably arranged in the power saving mode not to transmit any messages to the base station.

The relay is preferably arranged in the power saving mode to receive any messages from the user equipment.

The base station processor is preferably arranged to detect the at least one user equipment is in a lower level node power saving mode.

The base station processor is preferably arranged to receive a message from the relay requesting the relay to enter a power saving mode.

The base station processor is preferably arranged to detect the at least one user equipment power saving mode receive period.

The base station processor is preferably arranged to transmit a message to the relay requesting the relay enter the power saving mode when the at least one user equipment is not in the receive period.

The base station processor is preferably arranged to communicate to at least two user equipment via the relay, and wherein the base station processor is arranged to detect that all of the at least two user equipment are in a user equipment power saving mode.

The base station processor is preferably further arranged to detect the user equipment power saving receive periods for all of the user equipment.

The base station processor is preferably further arranged to transmit a message to the relay to request the relay to enter the power saving mode when at least one of the at least two lower level nodes is not in the receive period.

The base station processor is preferably further arranged detect a period between a first user equipment power saving mode receive period and a second user equipment power saving mode receive period.

The base station processor is preferably arranged to reduce the period between a first user equipment power saving mode receive period and a second user equipment power saving mode receive period.

The base station processor is preferably arranged to modify at least one of the first and second user equipment power saving mode receive periods, so that the period between a first user equipment power saving mode receive period and a second user equipment power saving mode receive period is reduced.

The base station processor is preferably arranged to transmit a message to at least one of the first and second user equipment requesting at least one of the respective first and second user equipment power saving mode receive periods is modified, so that the period between a first user equipment power saving mode receive period and a second user equipment power saving mode receive period is reduced.

According to a third aspect of the invention there is provided a user equipment for use in a communications network, said user equipment arranged to receive data from and transmit data to at least one relay directly and further arranged to receive data from and transmit data to a base station via the relay, wherein the user equipment is further arranged to enter a power saving mode to not receive any messages transmitted by the relay for a first time period wherein the user equipment comprises: a processor arranged to receive a message requesting the user equipment to change the first time period to a further time period and further arranged to change the power saving mode from the first time period to the further time period.

According to a fourth aspect of the invention there is provided a communications system comprising a relay station as described above.

According to a fifth aspect of the invention there is provided a communications system comprising a base station as described above.

According to a sixth aspect of the invention there is provided a communications system comprising a user equipment as described above.

According to a seventh aspect of the invention there is provided a method for operating a relay for use in a communications network, said relay arranged to receive data from and transmit data to at least one higher level node and receive data from and transmit data to at least one lower level node, wherein the method comprises: entering a power saving mode.

Entering a power saving mode preferably comprises operating the relay so not to be able to receive any messages from the at least one higher level node.

Entering a power saving mode preferably comprises: operating the relay so not to be able to transmit any messages to the at least one higher level node.

Entering a power saving mode preferably comprises operating the relay to be able to receive any messages from the at least one lower level node.

The method for operating a relay preferably further comprising: detecting the at least one lower level node is in a lower level node power saving mode.

The method for operating a relay preferably further comprising: transmitting a message from the relay to the at least one higher level node requesting the relay to enter a power saving mode.

The method for operating a relay preferably further comprising detecting the lower level node power saving mode receive period.

Entering the power saving mode preferably comprises entering the power saving mode when the at least one lower level node is not in the receive period.

The method for operating a relay preferably further comprising receiving a message from the higher level node to enter the power saving mode for a specified period.

The processor is preferably arranged to communicate to at least two lower level nodes, the method further comprising detecting that all of the at least two lower level nodes are in a lower level node power saving mode.

The method for operating a relay preferably further comprising detecting the lower level node power saving receive periods for all of the lower level nodes.

The method for operating a relay preferably further comprising entering the power saving mode when at least one of the at least two lower level nodes is not in the receive period.

The method for operating a relay preferably further comprising detecting a period between a first lower level node power saving mode receive period and a second lower level node power saving mode receive period.

The method for operating a relay preferably further comprising transmitting a message from the relay to the at least one higher level node requesting a reduction of the period between a first lower level node power saving mode receive period and a second lower level node power saving mode receive period.

The method for operating a relay preferably further comprising transmitting a message from the relay to the at least one higher level node requesting at least one of the first and second lower level node power saving mode receive periods is modified, so that the period between a first lower level node power saving mode receive period and a second lower level node power saving mode receive period is reduced.

The method for operating a relay preferably further comprising transmitting a message from the relay to at least one of the first and second lower level nodes requesting at least one of the respective first and second lower level node power saving mode receive periods is modified, so that the period between a first lower level node power saving mode receive period and a second lower level node power saving mode receive period is reduced.

According to an eighth aspect of the invention there is provided a method for operating a base station for use in a communications network, said base station arranged to receive data from and transmit data to at least one relay directly and further arranged to receive data from and transmit data to at least one user equipment via the relay, wherein the method comprises transmitting a message from the base station to the relay requesting the relay to enter a power saving mode.

The relay is preferably arranged in the power saving mode to not receive any messages from the base station.

The relay is preferably arranged in the power saving mode not to transmit any messages to the base station.

The relay is preferably arranged in the power saving mode to receive any messages from the user equipment.

The method for operating a base station preferably further comprising detecting the at least one user equipment is in a lower level node power saving mode.

The method for operating a base station preferably further comprising receiving a message from the relay requesting the relay to enter a power saving mode.

The method for operating a base station preferably further comprising detecting the at least one user equipment power saving mode receive period.

The method for operating a base station preferably further comprising transmitting a message from the base station to the relay requesting the relay enter the power saving mode when the at least one user equipment is not in the receive period.

The base station is preferably arranged to communicate to at least two user equipment via the relay, and preferably further comprising detecting that all of the at least two user equipment are in a user equipment power saving mode.

The method for operating a base station preferably further comprising detecting the user equipment power saving receive periods for all of the user equipment.

The method for operating a base station preferably further comprising transmitting a message from the base station to the relay to request the relay to enter the power saving mode when at least one of the at least two lower level nodes is not in the receive period.

The method for operating a base station preferably further comprising detecting a period between a first user equipment power saving mode receive period and a second user equipment power saving mode receive period.

The method for operating a base station preferably further comprising modifying the period between a first user equipment power saving mode receive period and a second user equipment power saving mode receive period.

The method for operating a base station preferably further comprising receiving a message from the relay requesting at least one of the first and second user equipment power saving mode receive periods is modified, so that the period between a first user equipment power saving mode receive period and a second user equipment power saving mode receive period is reduced.

The method for operating a base station preferably further comprising transmitting a message from the base station to at least one of the first and second user equipment requesting at least one of the respective first and second user equipment power saving mode receive periods is modified, so that the period between a first user equipment power saving mode receive period and a second user equipment power saving mode receive period is reduced.

According to a ninth aspect of the present invention a method for operating a user equipment for use in a communications network, said user equipment arranged to receive data from and transmit data to at least one relay directly and further arranged to receive data from and transmit data to a base station via the relay, wherein the user equipment is further arranged to enter a power saving mode to not receive any messages transmitted by the relay for a first time period wherein the method comprises: receiving a message requesting the user equipment to change the first time period to a further time period; and changing the power saving mode for the user equipment from the first time period to the further time period.

According to a tenth aspect of the present invention there is provided a computer program arranged to operate a computer to perform a method for operating a relay, said relay arranged to receive data from and transmit data to at least one higher level node and receive data from and transmit data to at least one lower level node, wherein the method comprises entering a power saving mode.

According to an eleventh aspect of the present invention there is provided a computer program arranged to operate a computer to perform a method for operating a base station for use in a communications network, said base station arranged to receive data from and transmit data to at least one relay directly and further arranged to receive data from and transmit data to at least one user equipment via the relay, wherein the method comprises transmitting a message from the base station to the relay requesting the relay to enter a power saving mode.

According to a twelfth aspect of the present invention there is provided a computer program arranged to operate a computer to perform a method for operating a user equipment for use in a communications network, said user equipment arranged to receive data from and transmit data to at least one relay directly and further arranged to receive data from and transmit data to a base station via the relay, wherein the user equipment is further arranged to enter a power saving mode to not receive any messages transmitted by the relay for a first time period wherein the method comprises: receiving a message requesting the user equipment to change the first time period to a further time period; and changing the power saving mode for the user equipment from the first time period to the further time period.

### BRIEF DESCRIPTION OF DRAWINGS

For a better understanding of the present invention and as to how the same may be carried out, reference will now be made by way of example only to the accompanying figures in which:

FIG. 1 shows part of a communications network within which embodiments of the present invention can be implemented;

FIG. 2 shows a relay unit embodying the present invention as shown in FIG. 1;

FIG. 3 shows a schematic view of the signal flow in one embodiment of the invention as implemented by the relay unit shown in FIG. 2;

FIG. 4 shows a timing model of the UE and RS active periods of the first and second embodiments of the invention;

FIG. 5 shows a schematic view of the signal flow in the second embodiment of the invention as implemented by the relay unit shown in FIG. 2; and

FIG. 6 shows a schematic view of the signal flow in a third embodiment of the invention as implemented by the relay unit shown in FIG. 2.

### DETAILED DESCRIPTION OF PREFERRED EMBODIMENTS OF THE INVENTION

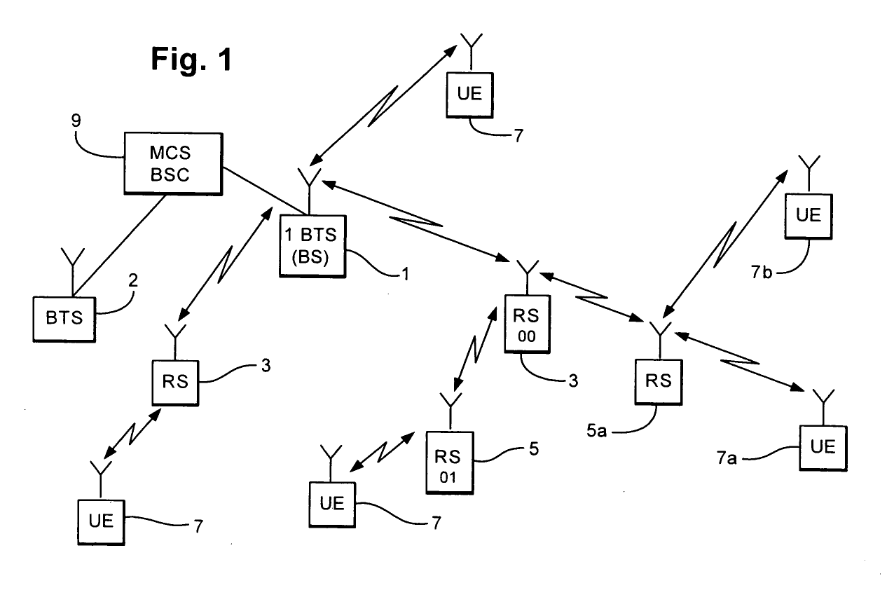

FIG. 1 shows an communications network. The communications network comprises base transceiver stations (BS) 1,2 also known as base stations. The base stations (BS) 1,2 are arranged to be capable of communicating with a base station controller (BSC) 9. In other embodiments the base stations are arranged to be capable of communicating with any known public land mobile network (PLMN) infrastructure. The base stations 1, 2 are also arranged to be capable of communicating with user equipment 7. The base stations are also arranged to be capable of communicating with relay stations (RS) 3,5.

The relay stations (RS) 3,5 are arranged to be capable of communicating with the base transceiver stations (BS) 1, 2. The relay stations are also capable of connecting to a mobile station (MS) 7. The relay stations (RS) 3, 5 are also capable of communicating to other relay stations (RS) 5, 3.

The linking of the relay stations is also shown in FIG. 1. FIG. 1 shows a first group of relay stations 3 which are connected directly to the base station 1 and a second group of relay stations 5 which are connected to the base station 1 via the first group of relay stations 3. Although not shown in FIG. 1 this chaining can be extended so that further groups of relay stations are connected to the base station via the previous groups of relay stations. To further assist the understanding of the present invention one of the first group of relay stations 3 has been given the reference value RS00 and one of the second group of relay stations 5 has been given the reference value RS01. These reference values are exemplary only and could be applied to any two chained relay stations—i.e. the below described examples can be applied to any two connected relay stations of adjacent groups.

The user equipment (UE), mobile station (MS) or subscriber station (SS) can be any suitable form of user equipment such as a mobile station, mobile telephone, personal organiser, PDA (personal digital assistant), computer, portable computer, notebook or the like.

In practice many more user equipment are provided. It should also be appreciated that in some embodiments of the invention a relay unit may be able to communicate with more than one base station. To aid the understanding of the invention the examples discussed will concern the part of the network comprising the base station 1, relay station 5a, and user equipment 7a and 7b. It would be understood by the person skilled in the art that other arrangements of entities would also be possible.

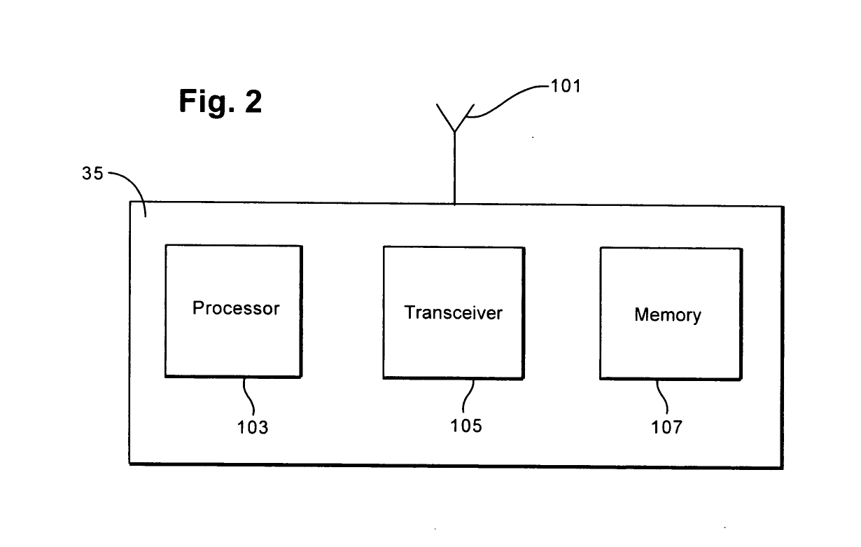

The relay station (RS) 5a embodying the present invention is shown in more detail in FIG. 2. The relay station RS 5a comprises an antenna 101 arranged to be capable of transmitting and receiving radio frequency signals from base station 1, user equipment 7a, 7b and other relay stations 3, 5. The antenna 101 may comprise an antenna array capable of beam forming and transmitting or receiving signals to or from a specific spatial direction.

The relay station RS further comprises a transceiver 105 connected to the antenna 101 and arranged to be capable of receiving radio frequency signals from the antenna and outputting base band signals and receiving base band signals and transmitting radio frequency signals to the antenna 101 for transmission.

The relay station RS 5a further comprises a processor 103 arranged to control the transceiver and for operating the relay station memory 107.

The relay station RS 5a further comprises memory 107, which is arranged to store instructions for the operation of the relay station 5a. Furthermore the memory can be arranged to buffer received data prior to being re-transmitted to its destination. In some embodiments of the invention a separate memory may be used for storing different types of data, i.e. the received data may be stored on a magnetic storage media and the instructions stored on semiconductor memory devices.

It should be appreciated that the example of the relay station shown in FIG. 2 illustrates the functionality. It should be appreciated that aspects of the transceiver circuitry 105 may be incorporated in the processor 103 and vice versa.

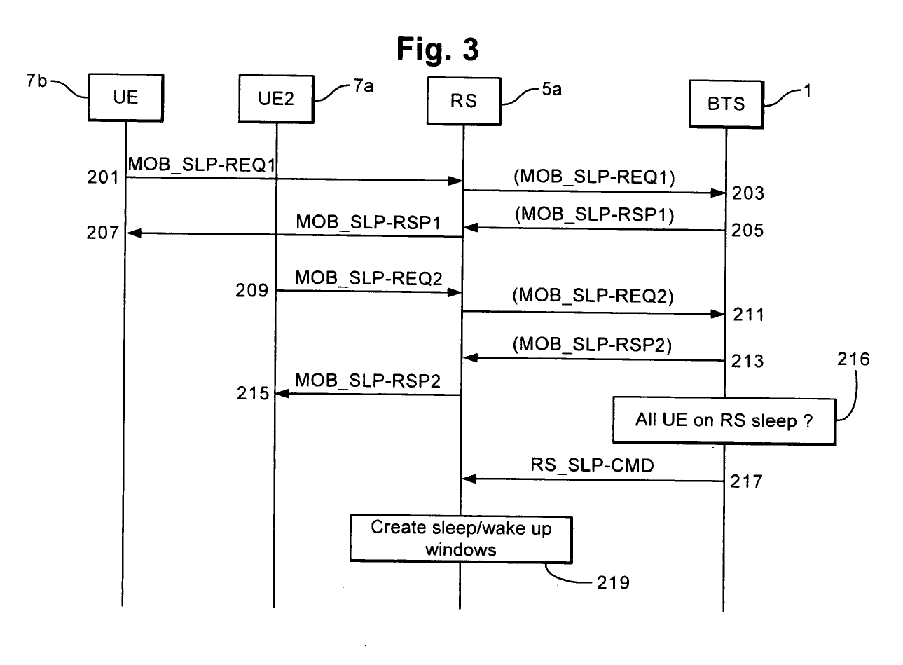

FIG. 3 shows a timing diagram demonstrating a first embodiment of the present invention. The timing diagram shows the first user equipment UE1 7b, the second user equipment UE2 7a, the relay station RS 5a and the base station BS1.

When the user equipment wishes to achieve power efficiency and enter a sleep or power conservation mode, it transmits, in step 201, a message to the base station, via the relay station. The message is a sleep request message (MOB_SLP-REQ1). The relay station on receipt of the sleep request message forwards the sleep request message in step 203. The base station 1 transmits a response to the request, back to the UE1 via the relay station RS in a form as a sleep response message (MOB_SLP-RSP1) in step 205. This is forwarded from the relay station to the user equipment in step 207. The response message instructs the user equipment to only switch on its reception capabilities and therefore be capable of receiving messages for a fraction of time of the communications frame period. This permits the UE to conserve power as it does not have to power the receiver or processes related to receiving except at the designated times.

The steps 209, 211, 213 and 215 repeat the same sleep request/response process for the second user equipment UE2 7a. Thus in steps 209 and 211, the UE2 transmits an MOB_SLP-REQ2 message to the base station via the relay station. In steps 213 and 215, the base station transmits to the UE2 via the relay station the response message MOB_SLP-RSP2. The response message once again instructs the second user equipment to only be capable of receiving messages during a certain fraction of the frame period.

In step 216, the base station determines that all user equipment attached to the relay station 5a are currently in sleep mode. On determination that all of the UE for a relay station are in sleep mode, the base station, in step 217, transmits a sleep command message to the relay station (RS_SLP-CMD). The sleep command passed to the relay station contains information relating to the various time periods that the user equipment are designated to be able to receive messages, in other words when the user equipment associated with the relay station are accessible and therefore when the user equipment associated with the relay station are not accessible.

In step 219, the relay station examines the information passed by the command and creates a sleep/wake-up window within which the relay station has to be active in order to receive messages from the base station and transmit them to the user equipment. The relay station during these sleep window portions is able to shut down the receiving circuitry receiving from the base station.

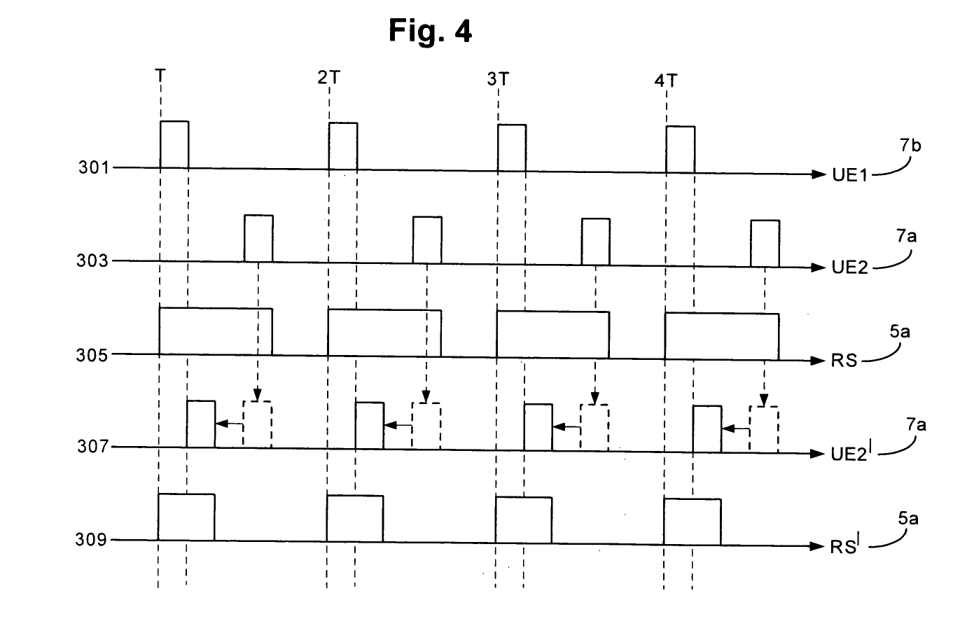

These sleep/wake-up windows are shown in FIG. 4 below.

In FIG. 4 each line 303, 305, 307, 309, 311 represents a schematic view of the timing chart indicating whether or not a user equipment or relay station is able to receive or transmit data. Each line has a horizontal axis defining time and a vertical axis defining whether the device is active. When the line is above the horizontal axis, the device (UE or RS) is active or in a receive period and when the line is level with the horizontal axis the device is in sleep mode or also known as a sleep period. The lines are divided up into frames which are regular time periods. For example, the line 301 shows that the first user equipment UE1 is only active or capable of receiving data from BS and RS for a short period at the start of each frame. Furthermore, as can be seen in line 303, the second user equipment 7a is active or only capable of receiving data for a short period during the middle of each time frame. In such a situation as can be seen in FIG. 4 line 305, the relay station is required to stay active or be capable of receiving data for the UE from the BS for a window which includes both the first and second user equipment active periods during the frame.

Therefore, there is some saving with regards to not requiring the relay station to be capable of receiving data from the BS for the whole time duration and therefore reduce the average power requirement.

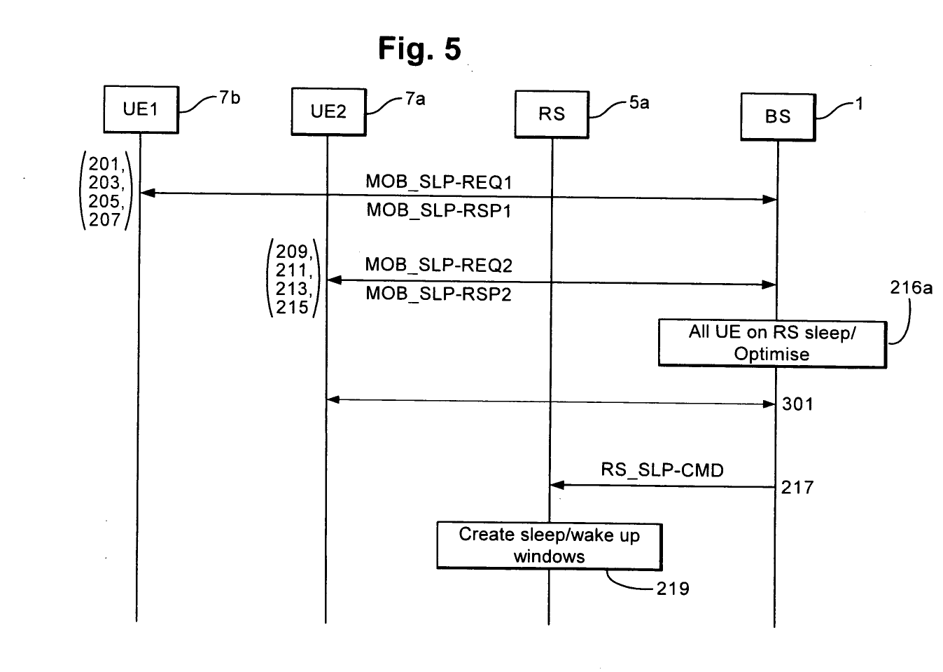

FIG. 5 shows a timing schematic diagram for data flow for a second embodiment of the present invention. Where the same network elements or messages are exchanged as shown in FIG. 3, the same reference numerals are used.

The first four steps 201, 203, 205 and 207 show the same steps as shown in FIG. 3 with regards to the first user equipment UE1 requesting a sleep mode from the base station and receiving the sleep response message, with the same active period being designated.

The steps 209, 211, 213 and 215 also show the similar process as shown in FIG. 3 with regards to the second user equipment UE2 requesting a sleep mode and receiving a sleep response message from the base station, with the same ‘active’ period being designated.

In step 216a, the base station detects that all of the user equipment attached or associated to the relay station are ‘asleep’ or in sleep mode. It may also detect that the arrangement of sleep mode active periods (also known as receive periods) designated to the user equipment is not optimal and performs an optimisation process to reduce the potential time required for the relay station to be ‘active’. It implements this by adjusting the UE ‘active’ periods so that they follow each other.

Following this optimisation step, when the optimisation step detects an improvement can be implemented, the base station transmits, in step 301, to at least one of the user equipment, a further message to adjust the ‘active period for the UE. For example, one embodiment transmits a further sleep response message (MOB_SLP-REP 3) which redesignates the ‘active’ period i.e. causes the user equipment to realign its ‘active’ period of the frame so that there are as few as possible gaps between the ‘active’ periods between all of the user equipment attached to the relay station currently in sleep mode.

Having aligned the sleep periods to optimise the amount of time in an active part, the base station transmits the sleep command to the relay station as described above with respect to step 217 in FIG. 3.

Furthermore, the relay station creates the sleep/wake-up windows and implements the switch on/switch off process for the relay station as has been previously described with respect to step 219 in FIG. 3 also.

An improvement with regards to the amount of time required by the relay station to be ‘active’ i.e. be capable of receiving from the BS, can therefore be seen in lines 307 and 309 of FIG. 4. Line 307 of FIG. 4 shows where the second user equipment active time period is adjusted to follow directly after the ‘active’ period of the first user equipment. Line 309 of FIG. 4, shows that the ‘active’ period required to be used by the relay station following this alignment is much smaller than the ‘active’ period required in line 305 i.e. the previous embodiment.

Embodiments of the invention are also applicable to reduce power consumption in multi-hop chains of relay stations, i.e. relay stations linked to other relay stations as well as to the user equipment and base station. In these multi-hop chains the relay station can be placed into a sleep mode as described above using a command as previously described when all of the UE associated with the candidate relay station are in sleep mode and when all of the user equipment associated with all of the relay stations in the communications levels below (i.e. in the direction away from the base station) the candidate relay station are in sleep mode.

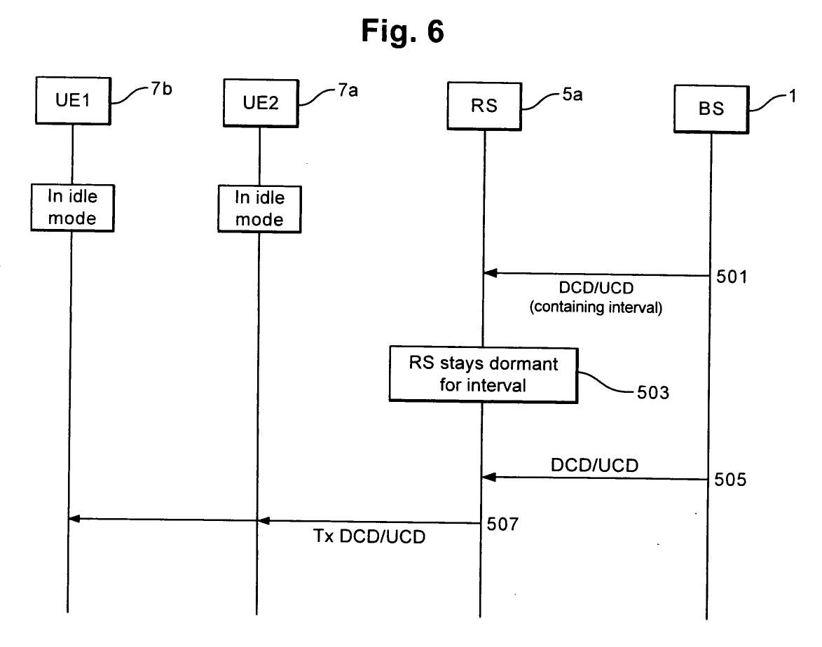

FIG. 6 shows a further embodiment of the present invention, which allows power saving for the broadcast messages. In FIG. 6, the user equipment 7a, 7b attached to the relay station 5a are shown to be in an idle mode. Typically user equipment in the idle mode receive a broadcast message transmitted from the base station 1 to the relay station 5a which is then forwarded to the various user equipment 7a, 7b in idle mode. The step 501 shows the broadcast message containing the downlink channel descriptor (DCD) and uplink channel descriptor (UCD). The DCD and UCD enable the user equipment 7a, 7b to use the channel with regards to the base station. The DCD/UCD messages are sent after an interval. The relay station on receipt of the message 501 processes the interval time and the processor within the relay station switches off the ability to receive messages from the BS or stays ‘dormant’ for the period or interval defined in the DCD/UCD message. On receipt of the further DCD/UCD message after the interval time period, the relay station transmits the DCD/UCD information in step 507 to the user equipment.

These embodiments therefore produce power efficiency on the base station to relay station interface. On the relay station to the user equipment interface, if the user equipment has data or signalling to send, the relay station is available to receive it and then forward it to the base station if required.

Although as has been described with respect to the embodiments above that the base station detects whether the user equipment associated with a relay station are in sleep mode or idle mode, in other embodiments of the invention, the relay station processor may also store indications of which user equipment are in an active mode and therefore which are in a sleep mode and initiate the sleep mode in the relay station by sending a relay station sleep request to the base station. In other embodiments of the invention the relay station implements a sleep mode without first requesting a sleep mode from the base station.

The above described operations may require data processing in the various entities. The data processing may be provided by means of one or more data processors. Appropriately adapted computer program code product may be used for implementing the embodiments, when loaded to a computer. The program code product for providing the operation may be stored on and provided by means of a carrier medium such as a carrier disc, card or tape. A possibility is to download the program code product via a data network. Implementation may be provided with appropriate software in a server.

It is noted that whilst in the above embodiments are described in relation to user equipment such as mobile stations, embodiments of the present invention are applicable to any other suitable type of user equipment.

It is also noted that even though the exemplifying communication system shown and described in more detail in this disclosure uses the terminology of WiMAX (Worldwide Interoperability for Microwave Access) or IEEE 802.16 WG, embodiments of the proposed solution can be used in any communication system wherein advantage may be obtained by means of the embodiments of the invention. The invention is not limited to environments such as cellular mobile or WLAN systems either. The invention could be for example implemented as part of the network of computers known as the “Internet”, and/or as an “Intranet”. Furthermore the user equipment 14 in some embodiments of the present invention can communicate with the network via a fixed connection, such as a digital subscriber line (DSL) (either asynchronous or synchronous) or public switched telephone network (PSTN) line via a suitable gateway.

It is also noted that while the above describes exemplifying embodiments of the invention, there are several variations and modifications which may be made to the disclosed solution without departing from the scope of the present invention as defined in the appended claims.

What is claimed:

1. A relay for use in a communications network, wherein the relay comprises:
a processor configured to control the relay to enter a power saving mode,
wherein said relay is configured to receive data from and transmit data to at least one higher level node and receive data from and transmit data to at least one lower level node.

2. A relay as claimed in claim 1, wherein the processor is configured in the power saving mode to not receive any messages from the at least one higher level node.

3. A relay as claimed in claim 2, wherein the processor is configured in the power saving mode to not transmit any messages to the at least one higher level node.

4. A relay as claimed in claim 2, wherein the processor is further configured in the power saving mode to receive any messages from the at least one lower level node.

5. A relay as claimed in claim 1, wherein the processor is configured to detect the at least one lower level node is in a lower level node power saving mode.

6. A relay as claimed in claim 5, wherein the processor is configured to transmit a message to the at least one higher level node requesting the relay to enter a power saving mode.

7. A relay as claimed in claim 5, wherein the processor is further configured to detect the lower level node power saving mode sleep period and/or receive period.

8. A relay as claimed in claim 7, wherein the processor is further configured to control the relay to enter the power saving mode when the at least one lower level node is not in the receive period.

9. A relay as claimed in claim 1, wherein the processor is configured to receive a message from the higher level node to enter the power saving mode for a specified period.

10. A relay as claimed in claim 1, wherein the processor is further configured to communicate to at least two lower level nodes, and wherein the processor is arranged to detect that all of the at least two lower level nodes are in a lower level node power saving mode.

11. A relay as claimed in claim 10, wherein the processor is further configured to detect the lower level node power saving receive periods for all of the lower level nodes.

12. A relay as claimed in claim 11, wherein the processor is further configured to control the relay to enter the power saving mode when at least one of the at least two lower level nodes is not in the receive period.

13. A relay as claimed in claim 10, wherein the processor is further configured detect a period between a first lower level node power saving mode receive period and a second lower level node power saving mode receive period.

14. A relay as claimed in claim 13, wherein the processor is further configured to transmit a message to the at least one higher level node requesting a reduction of the period between a first lower level node power saving mode receive period and a second lower level node power saving mode receive period.

15. A relay as claimed in claim 13, wherein the processor is further configured to transmit a message to the at least one higher level node requesting at least one of the first and second lower level node power saving mode receive periods is modified, so that the period between a first lower level node power saving mode receive period and a second lower level node power saving mode receive period is reduced.

16. A relay as claimed in claim 13, wherein the processor is further configured to transmit a message to at least one of the first and second lower level nodes requesting at least one of the respective first and second lower level node power saving mode receive periods is modified, so that the period between a first lower level node power saving mode receive period and a second lower level node power saving mode receive period is reduced.

17. A base station for use in a communications network, wherein the base station comprises:
a processor configured to transmit a message to at least one relay, requesting the at least one relay to enter a power saving mode,
wherein said base station is configured to receive data from and transmit data to at least one relay directly and further configured to receive data from and transmit data to at least one user equipment via the at least one relay.

18. A base station as claimed in claim 17, wherein the at least one relay is configured in the power saving mode to not receive any messages from the base station.

19. A base station as claimed in claim 17, wherein the at least one relay is configured in the power saving mode to not transmit any messages to the base station.

20. A base station as claimed in claim 17, wherein the at least one relay is configured in the power saving mode to receive any messages from the user equipment.

21. A base station as claimed in claim 17, wherein the base station processor is configured to detect the at least one user equipment is in a lower level node power saving mode.

22. A base station as claimed in claim 17, wherein the base station processor is configured to receive a message from the relay requesting the relay to enter a power saving mode.

23. A base station as claimed in claim 21, wherein the base station processor is further configured to detect the at least one user equipment power saving mode receive period.

24. A base station as claimed in claim 23, wherein the base station processor is further configured to transmit a message to the relay requesting the at least one relay to enter the power saving mode when the at least one user equipment is not in the receive period.

25. A base station as claimed in claim 17, wherein the base station processor is configured to communicate to at least two user equipment via the at least one relay, and wherein the base station processor is further configured to detect that all of the at least two user equipment are in a user equipment power saving mode.

26. A base station as claimed in claim 25, wherein the base station processor is further configured to detect the user equipment power saving receive periods for all of the user equipment.

27. A base station as claimed in claim 26, wherein the base station processor is further configured to transmit a message to the relay to request the relay to enter the power saving mode when at least one of the at least two lower level nodes is not in the receive period.

28. A base station as claimed in claim 25, wherein the base station processor is further configured to detect a period between a first user equipment power saving mode receive period and a second user equipment power saving mode receive period.

29. A base station as claimed in claim 28, wherein the base station processor is further configured to reduce the period between a first user equipment power saving mode receive period and a second user equipment power saving mode receive period.

30. A base station as claimed in claim 28, wherein the base station processor is further configured to modify at least one of the first and second user equipment power saving mode receive periods, so that the period between a first user equipment power saving mode receive period and a second user equipment power saving mode receive period is reduced.

31. A base station as claimed in claim 28, wherein the base station processor is further configured to transmit a message to at least one of the first and second user equipment, requesting at least one of the respective first and second user equipment power saving mode receive periods to be modified, so that the period between a first user equipment power saving mode receive period and a second user equipment power saving mode receive period is reduced.

32. A user equipment for use in a communications network, wherein the user equipment comprises:
a processor configured to receive a message requesting the user equipment to change the first time period to a further time period and further arranged to change the power saving mode from the first time period to the further time period; and
said user equipment is configured to receive data from and transmit data to at least one relay directly and further configured to receive data from and transmit data to a base station via the relay, wherein the user equipment is further configured to enter a power saving mode to not receive any messages transmitted by the relay for a first time period wherein.

33. A communications system comprising a relay station as claimed in claim 1.

34. A communications system comprising a base station as claimed in claim 17.

35. A communications system comprising a user equipment as claimed in claim 32.

36. A method for operating a relay, the method comprising:
configuring said relay to receive data from and transmit data to at least one higher level node and receive data from and transmit data to at least one lower level node; and
entering a power saving mode,
wherein the relay is configured for use in a communications network.

37. A method for operating a relay as claimed in claim 36, wherein entering a power saving mode further comprises,
operating the relay so not to be able to receive any messages from the at least one higher level node.

38. A method for operating a relay as claimed in claim 36, wherein entering a power saving mode further comprises:
operating the relay so not to be able to transmit any messages to the at least one higher level node.

39. A method for operating a relay as claimed in claim 36, wherein entering a power saving mode further comprises operating the relay to be able to receive any messages from the at least one lower level node.

40. A method for operating a relay as claimed in claim 36, further comprising:
detecting the at least one lower level node is in a lower level node power saving mode.

41. A method for operating a relay as claimed in claim 40, further comprising:
transmitting a message from the relay to the at least one higher level node requesting the relay to enter a power saving mode.

42. A method for operating a relay as claimed in claim 40, further comprising detecting the lower level node power saving mode receive period.

43. A method for operating a relay as claimed in claim 42, wherein entering the power saving mode further comprises entering the power saving mode when the at least one lower level node is not in the receive period.

44. A method for operating a relay as claimed in claim 36, further comprising receiving a message from the higher level node to enter the power saving mode for a specified period.

45. A method for operating a relay as claimed in claim 36, wherein the processor is configured to communicate to at least two lower level nodes, the method further comprising detecting that all of the at least two lower level nodes are in a lower level node power saving mode.

46. A method for operating a relay as claimed in claim 45, further comprising detecting the lower level node power saving receive periods for all of the lower level nodes.

47. A method for operating a relay as claimed in claim 46, further comprising, entering the power saving mode when at least one of the at least two lower level nodes is not in the receive period.

48. A method for operating a relay as claimed in claim 45, further comprising detecting a period between a first lower level node power saving mode receive period and a second lower level node power saving mode receive period.

49. A method for operating a relay as claimed in claim 48, further comprising transmitting a message from the relay to the at least one higher level node requesting a reduction of the period between a first lower level node power saving mode receive period and a second lower level node power saving mode receive period.

50. A method for operating a relay as claimed in claim 48, further comprising transmitting a message from the relay to the at least one higher level node requesting at least one of the first and second lower level node power saving mode receive periods is modified, so that the period between a first lower level node power saving mode receive period and a second lower level node power saving mode receive period is reduced.

51. A method for operating a relay as claimed in claim 48, further comprising transmitting a message from the relay to at least one of the first and second lower level nodes requesting at least one of the respective first and second lower level node power saving mode receive periods is modified, so that the period between a first lower level node power saving mode receive period and a second lower level node power saving mode receive period is reduced.

52. A method for operating a base station for use in a communications network, the method comprising:
configuring the base station for use in a communications network and further configuring the base station to receive data from and transmit data to at least one relay directly and further configured to receive data from and transmit data to at least one user equipment via the relay; and
transmitting a message from the base station to the relay requesting the relay to enter a power saving mode.

53. A method for operating a base station as claimed in claim 52, wherein the relay is further configured in the power saving mode, to not receive any messages from the base station.

54. A method for operating a base station as claimed in claim 52, wherein the relay is further configured in the power saving mode to not transmit any messages to the base station.

55. A method for operating a base station as claimed in claim 52, wherein the relay is further configured in the power saving mode to receive any messages from the user equipment.

56. A method for operating a base station as claimed in claim 52, further comprising detecting the at least one user equipment is in a lower level node power saving mode.

57. A method for operating a base station as claimed in claim 52, further comprising receiving a message from the relay requesting the relay to enter a power saving mode.

58. A method for operating a base station as claimed in claim 56, further comprising detecting the at least one user equipment power saving mode receive period.

59. A method for operating a base station as claimed in claim 58, further comprising transmitting a message from the base station to the relay, requesting the relay to enter the power saving mode when the at least one user equipment is not in the receive period.

60. A method for operating a base station as claimed in claim 52, wherein the base station is configured to communicate to at least two user equipment via the relay, and further comprising detecting that all of the at least two user equipment are in a user equipment power saving mode.

61. A method for operating a base station as claimed in claim 60, further comprising detecting the user equipment power saving receive periods for all of the user equipment.

62. A method for operating a base station as claimed in claim 61, further comprising transmitting a message from the base station to the relay to request the relay to enter the power saving mode when at least one of the at least two lower level nodes is not in the receive period.

63. A method for operating a base station as claimed in claim 60, further comprising detecting a period between a first user equipment power saving mode receive period and a second user equipment power saving mode receive period.

64. A method for operating a base station as claimed in claim 63, further comprising modifying the period between a first user equipment power saving mode receive period and a second user equipment power saving mode receive period.

65. A method for operating a base station as claimed in claim 63, further comprising receiving a message from the relay requesting at least one of the first and second user equipment power saving mode receive periods is modified, so that the period between a first user equipment power saving mode receive period and a second user equipment power saving mode receive period is reduced.

66. A method for operating a base station as claimed in claim 63, further comprising transmitting a message from the base station to at least one of the first and second user equipment requesting at least one of the respective first and second user equipment power saving mode receive periods is modified, so that the period between a first user equipment power saving mode receive period and a second user equipment power saving mode receive period is reduced.

67. A method for operating a user equipment, the method comprising:
configuring the user equipment to receive data from and transmit data to at least one relay directly and further configured to receive data from and transmit data to a base station via the relay;
receiving a message requesting the user equipment to change the first time period to a further time period; and
changing the power saving mode for the user equipment from the first time period to the further time period,
wherein the user equipment is configured for use in a communications network and the user equipment is further configured to enter a power saving mode, to not receive any messages transmitted by the relay for a first time period.

68. A computer program embodied on a computer readable medium, the computer program comprising computer code to operate a computer to perform a method for operating a relay, said relay configured to receive data from and transmit data to at least one higher level node and receive data from and transmit data to at least one lower level node, wherein the method comprises entering a power saving mode.

69. A computer program embodied on a computer readable medium, the computer program comprising computer code to operate a computer to perform a method for operating a base station for use in a communications network, said base station arranged to receive data from and transmit data to at least one relay directly and further arranged to receive data from and transmit data to at least one user equipment via the relay, wherein the method comprises transmitting a message from the base station to the relay requesting the relay to enter a power saving mode.

70. A computer program embodied on a computer readable medium, the computer program comprising computer code to operate a computer to perform a method for operating a user equipment for use in a communications network, said user equipment configured to receive data from and transmit data to at least one relay directly and further configured to receive data from and transmit data to a base station via the relay, wherein the user equipment is further configured to enter a power saving mode to not receive any messages transmitted by the relay for a first time period wherein the method comprises:
receiving a message requesting the user equipment to change the first time period to a further time period; and
changing the power saving mode for the user equipment from the first time period to the further time period.
